(19) United States
(12) Patent Application Publication
(10) Pub. No.: US 2014/0188750 A1
(43) Pub. Date: Jul. 3, 2014

(54) Method For Shipping

(71) Applicant: Alternative Courier, Inc., Schaumburg, IL (US)

(72) Inventor: Randall W. Seiler, Hoffman Estates, IL (US)

(73) Assignee: Alternative Courier, Inc., Schaumburg, IL (US)

(21) Appl. No.: 14/141,274

(22) Filed: Dec. 26, 2013

Related U.S. Application Data
(60) Provisional application No. 61/745,900, filed on Dec. 26, 2012.

(51) Int. Cl. G06Q 10/08

(52) U.S. Cl. CPC G06Q 10/08345; G06Q 10/0834
USPC 705/335; 705/334

(57) ABSTRACT

A method of facilitating the shipment of items wherein independent couriers and courier companies are registered and provided with a profile. Parameters associated with courier jobs are received from the courier businesses and it is determined which of the independent couriers are qualified to accept or bid on each courier job. A list detailing the parameters for each courier job that each independent courier is qualified to accept or bid on is provided to each independent courier. Each independent courier list is dynamically modified each time parameters for a new courier job each independent courier is qualified to accept or bid on is received.

### RELATED APPLICATIONS

This application claims priority to U.S. Provisional Application Ser. No. 61/745,900 filed Dec. 26, 2012, the contents of which are fully incorporated herein by reference.

### FIELD OF THE INVENTION

The present invention is related to a method for providing and obtaining shipping services.

### BACKGROUND OF THE INVENTION

In order to provide for the shipping or courier of items, courier businesses may employ at least one employee as a courier or deliveryman who is responsible for the carriage and delivery of various items. Having such employees, however, may cost the courier business substantial amounts of capital, as the expenses of employee wages, the costs associated with transportation used by the employees when making the deliveries including costs associated with vehicle purchases, maintenance, and insurance, and the heightened liability may make it less than ideal for many businesses to maintain a delivery or courier fleet.

Maintaining and managing a courier fleet also has the added expense of employing any required dispatchers and support staff the fleet may require. By reducing or eliminating a courier fleet, the support staff requirements may also be significantly reduced.

In addition to maintaining a courier or delivery fleet, or at least a large courier or delivery fleet, some courier businesses may use independent couriers or delivery services when necessary. These independent couriers or delivery services may, for a negotiated fee, pick up and deliver items to a desired location. However, when negotiating with an independent courier, courier businesses may have to go to great lengths and expend large amounts of time to obtain the best prices or independent couriers for the service. In some cases, there may be other local couriers or deliverymen or even independent couriers or deliverymen that would be willing to do the job and a much lower cost that the courier business may unknowingly fail to contact.

As such, it would be advantageous to have a service which provides a method whereby courier businesses can list courier jobs in the form of items that they would like to have couriered or shipped and multiple independent couriers or deliverymen can bid or accept jobs at a price offered by the courier business. If allowed access, non-courier businesses and individuals may likewise benefit from such a service.

The present invention is directed to solving these and other problems.

### SUMMARY OF THE INVENTION

The present invention is directed to a method and system to ship or deliver items.

According to one aspect of the invention, a method for facilitating the shipment of an item is provided. In order to facilitate shipment, at least one independent courier, and preferably multiple independent couriers, are registered with a service with each courier having a profile created based upon the courier's registration. At least one courier business or courier company, and preferably multiple courier companies, are also registered with the service, each courier business also having a profile created based upon the courier business's registration. When the courier business has a courier job in the form of an item which requires couriering or shipping, the courier business may provide parameters associated with the courier job to the service. The service will receive the courier jobs from each courier business and determine whether each independent courier registered with the service is qualified to accept or bid on the courier job based on the each independent courier's profile. When entering parameters for a courier job, each courier business may place additional requirements or limitations which may also be used be the service when determining whether any give independent courier is qualified to accept or bid on the courier job. Once the service has determined which independent couriers are qualified to accept or bid on each courier job, multiple lists will be created by the service, with at least one list being provided to each registered independent courier. The list provided to each independent courier will only include the courier jobs that particular independent courier is qualified to accept or bid on based on the independent courier's profile and the parameters entered for each courier job. Each independent courier may then accept any courier job as listed on their personalized list, or place a bid on any courier job as listed on their personalized list having terms different from the parameters entered by the courier business from whom the courier job was received by the service. Once an independent courier accepts offer, they will be responsible for delivering based on the parameters received from the courier business. If the independent courier placed a bid to deliver an item, the service will obtain a response from the courier business that provided the parameters for the courier job, and will notify the independent courier whether or not the bid has been accepted by the listing courier business or company.

According to another aspect of the invention, each independent courier may enter parameters or limitations further limiting the items provided by the service on the independent courier's personalized list. The service may provide a single list which includes only courier jobs which the independent courier has been deemed qualified for by the service and which fit the added limitations from the independent courier. Alternatively and more preferably, the service may provide two lists to each independent courier that enters additional limitations, a first list which includes all courier jobs which the service has deemed the independent courier qualified to accept and bid on, and a second list, where the first list is further modified to have all courier jobs which do not fit within the independent courier's parameters or limitations also removed.

According to one aspect of the invention, a method for facilitating the shipment of items is disclosed. In order to facilitate shipment, independent couriers may be registered. Each independent courier may have an independent courier profile stored on a server, each independent courier profile including the information provided during registration. Courier businesses may also be registered. Each courier business may have a courier business profile stored on the server, each courier business profile including the information provided during registration. Parameters for courier jobs may be received from the courier businesses, the parameters for the courier jobs being stored on the server. The independent couriers that are qualified to accept or bid on each received courier job will be determined based on the independent courier profile and the parameters for each courier job. A list will be provided to each independent courier detailing the parameters for each courier job it is determined each independent courier is qualified to accept or bid on. Every time a new courier job each independent courier is qualified to accept or bid on is received, each independent courier's list will be modified to include the new courier job.

According to another aspect of the invention, each independent courier may enter parameters or limitations further limiting the items provided by the service on the independent courier's personalized list. The service may provide a single list which includes only courier jobs which the independent courier has been deemed qualified for by the service and which fit the added limitations from the independent courier. Alternatively and more preferably, the service may provide two lists to each independent courier that enters additional limitations, a first list which includes all courier jobs which the service has deemed the independent courier qualified to accept and bid on, and a second list, where the first list is further modified to have all courier jobs which do not fit within the independent courier's parameters or limitations also removed.

Other aspects and features of the invention will become apparent to those having ordinarily skill in the art upon review of the following Description, Claims, and associated Drawings.

### BRIEF DESCRIPTION OF THE DRAWINGS

FIG. 1 is a flow chart showing steps of the method claimed herein;

FIG. 2 is a flow chart showing steps of the method claimed herein;

FIG. 3 shows an exemplary interface for use by an independent courier;

FIG. 4 shows an exemplary interface for use by an independent courier;

FIG. 5 shows an exemplary interface for use by an independent courier;

FIG. 6 shows an exemplary interface for use by an independent courier;

FIG. 7 shows an exemplary interface for use by an independent courier;

FIG. 8 shows an exemplary interface for use by an independent courier;

FIG. 9 shows an exemplary interface for use by an independent courier;

FIG. 10 shows an exemplary interface for use by an independent courier;

FIG. 11 shows an exemplary interface for use by an independent courier;

FIG. 12 shows an exemplary interface for use by an independent courier;

FIG. 13 shows an exemplary interface for use by an independent courier;

FIG. 14 shows an exemplary interface for use by an independent courier;

FIG. 15 shows an exemplary interface for use by an independent courier;

FIG. 16 shows an exemplary interface for use by an independent courier;

FIG. 17 shows an exemplary interface for use by an independent courier;

FIG. 18 shows an exemplary interface for use by an independent courier;

FIG. 19 is a flow chart showing steps of the method claimed herein;

FIG. 20 is a flow chart showing steps of the method claimed herein;

FIG. 21 is a flow chart showing steps of the method claimed herein;

FIG. 22 is a flow chart showing steps of the method claimed herein; and

FIG. 23 is a flow chart showing steps of the method claimed herein.

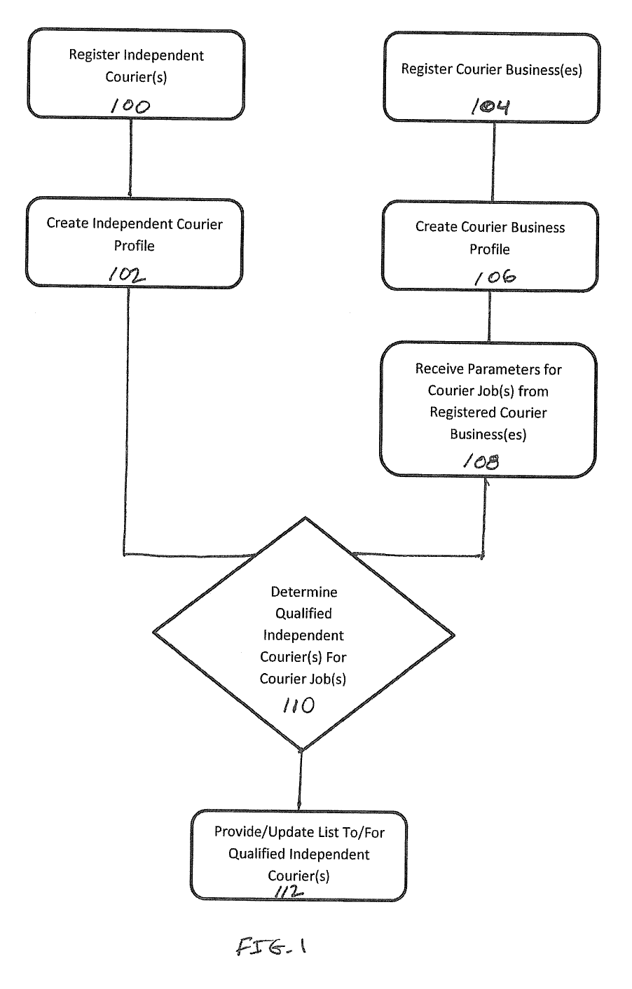

### DETAILED DESCRIPTION OF THE PRESENT INVENTION

While the present invention is susceptible of embodiment in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention provides a method for facilitating the shipment or couriering of items through and by a service which links independent couriers and individuals, businesses, and in particular courier businesses. The service or service provider provides the method herein to facilitate the shipment or couriering of items. While courier businesses will be discussed herein, it is contemplated by the invention that individuals and other, non-courier businesses, may likewise utilize the service to list items for courier as needed. Individuals or non-courier businesses may follow the procedure to list, pay for, and have courier jobs which include the shipment or courier of items as discussed herein with reference to courier businesses.

As used herein, the term independent courier will refer to a courier or deliveryman, or a group of couriers or deliverymen, who work independently and are not affiliated with a single business. Independent couriers may be, for example, independent contractors who offer courier or delivery services. As used herein the term courier business will refer a business or organization whose primary purpose is to ship and/or courier items. The term courier job refers to any job for the courier or shipment of items and all steps and processes included therein. Courier jobs generally including the courier or shipping or pick-up, transport, and delivery of items. Items which may be couriered or shipped include any item which may be couriered or shipped by an individual.

In order to provide the method, the service will register at least one independent courier (100), and preferably multiple independent couriers, who may accept and/or bid on listed or offered courier jobs through the service once they are registered. An independent courier profile including all information received during registration may be created for each independent courier registered with the service (102). In addition to registering at least one independent courier, at least one courier business, and preferably multiple courier businesses, will also be registered (104). A courier business profile including all information received during registration may also be created for each courier business (106).

Parameters associated with courier jobs are received by the service from registered courier businesses (108). Based on the received parameters, the service will determine whether the at least one courier is qualified to accept or bid on the courier job based on the independent courier's profile and registration information (110). Where multiple independent couriers are registered, the service will determine which independent couriers are qualified to accept or bid on the courier job. The service will provide and continually update and modify a list to the at least one, or each, independent courier which details the parameters associated with each courier job that the at least one, or each, independent courier is qualified to accept and bid on (112).

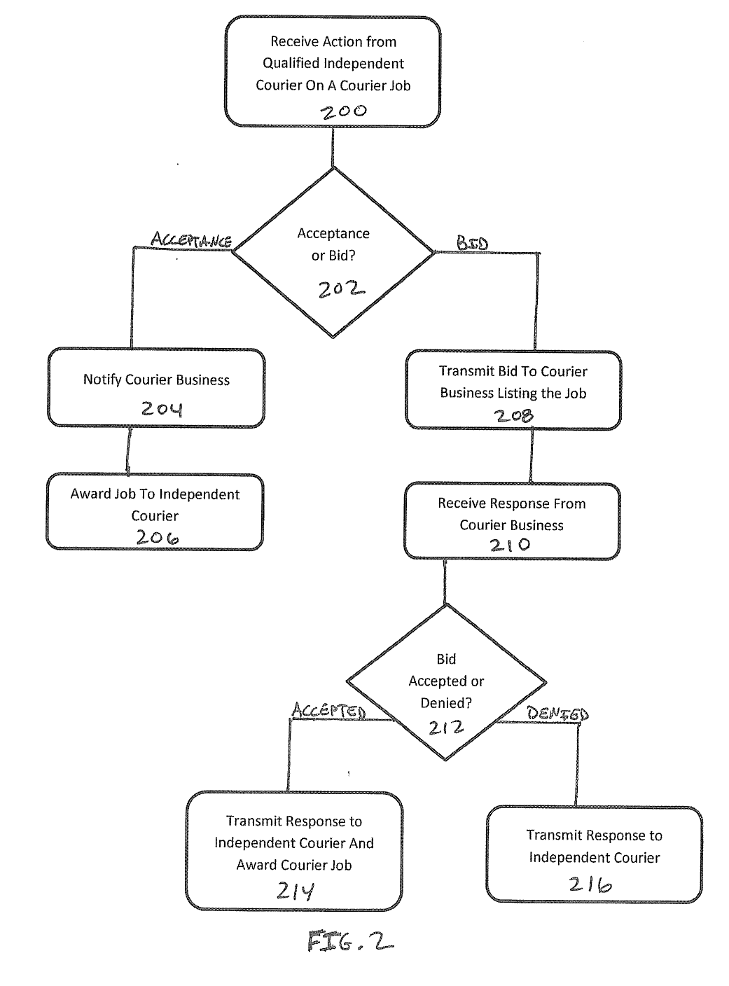

As seen in FIG. 2, from this list, the at least one, or each, independent courier may take action and accept a courier job as listed, or may provide a bid at a different price or with different parameters from those received from the courier business who provided the original parameters (200). The service will act accordingly whether an acceptance or bid is received (202). If an independent courier accepts the job or courier as listed, the courier business that provided the courier job will be notified (204) and the accepting independent courier will be responsible for completing the courier according to the parameters set by the at least one courier company (206).

If an independent courier instead provides a bid for the courier job, the service will transmit the bid to the courier business from whom the courier job was received (208). The courier business will then respond to the service (210) whether or not the bid is accepted or denied (212). If the bid is accepted, the at least one independent courier will be notified by the service, and the independent courier will be responsible for couriering the item as set by the independent courier in the bid (214). If the bid is denied, the courier will be notified (216) not be responsible for the courier of the item.

If an independent courier has made a bid for a courier job, the independent courier may withdraw the bid, so long as it has not been accepted by the listing courier business. If the independent courier withdraws the bid, the service will notify the courier company that the bid is no longer acceptable.

If a courier job is accepted by an independent courier or a bid by an independent courier has been accepted by a courier business, the service will automatically update the status of the courier job and remove the courier job from all independent courier's lists. The courier who has accepted or won a bid for a courier job will be provided with a list which shows all accepted or won, in progress courier jobs. This list may allow the independent courier to review the details of any jobs the independent courier is now responsible for. The independent courier may provide updates on the status of any open courier jobs which will be reflected on this list. The independent courier may also be provided with a second list which details all the courier jobs completed by the independent courier. Once a proof of delivery as discussed herein is provided, completed courier jobs may be removed from the independent courier's completed jobs list by the service.

Though it may be discussed at times in this application as at least one independent courier or the independent courier, the invention contemplates and works best when more than one independent courier is registered with the service. Once multiple independent couriers have registered with the service, every time courier parameters for a courier job are entered by a courier business, the service will determine which independent couriers are qualified to accept or bid on the courier job and modify the independent courier's list by adding the listing to the independent courier's list for review. The raw parameters or data received for all courier jobs is essentially transformed into multiple lists, at least one for each independent courier—or the at least one independent courier as the case may be—where each independent courier receives at least one list which only includes jobs they are qualified for. Similarly, the invention contemplates that at least one courier business or the courier business discussed at times works best when more than one courier business is registered with the service and listing courier jobs.

Registering independent couriers requires the service to obtain information from each independent courier which establishes the independent courier's qualifications for accepting or bidding on courier jobs. This information will be used to establish which courier jobs the service will provide to the independent courier. During registration, each independent courier may be required to provide information related to the type of vehicle(s) they use for delivery. Each independent courier may likewise be required to provide proof of insurance for their vehicle, proof of cargo insurance, the amount of cargo insurance they are insured for, proof of license for operating the vehicle(s) the independent courier has, and any courier or shipping licenses the independent courier may have. Courier or shipping licenses may include both intrastate and interstate shipping licenses, for any states the courier is licensed to ship or courier items in, as well as Transportation Security Administration authorization. As will be explained further herein, the information provided and received during registration will be used by the service to create the courier job list for each individual independent courier. Each independent courier may also be required to provide information such as an address or location from which they work, a home address if different than the work address, a phone number, and all information required for receiving payment from the service as an independent contractor. This information may be kept as registration information or be used to form an independent courier profile for each independent courier.

Once registered, each independent courier will be tracked and an on-time percentage for their deliveries will be stored by the service and added as part of any created profile for the independent courier. As with the registration information, the independent courier's on time percentage may be used by the service to determine which independent couriers are qualified or authorized to view, accept, and bid on particular courier jobs and modify or create the numerous independent courier lists.

In a similar manner, but with different requested information, courier businesses who wish to list courier jobs may also be required to register. Each courier business may be required to provide such information as an address, a phone number, proof of registration and any licensing requirements to operate in their locale, and payment information such as information related to a credit card or wire transfer account. The information registration received from each courier business may be utilized to create a courier business profile.

Once a courier business is registered, the service will be able to receive parameters for courier jobs to be listed with the service. The received courier job parameters, along with any specific parameters provided by the courier business, will be stored by the service and used to create the individual lists provided to each independent courier so that all independent couriers qualified to accept and bid on the courier job can accept or bid on the courier job. The courier business may accept, reject, or counter offer at a third price or different parameters if a bid is received.

For each courier job received by the service, basic parameters or information relative to the courier job may be required. For example, any time the service receives a courier job, the courier business listing or providing the courier job may be required to provide parameters like, the address where the item is to be picked up, the address for delivery, the type of vehicle required for delivery, the number of packages or items to be delivered, the price offered for pick-up and delivery, the time the item will be ready for pick-up, the time the item must be delivered by, the weight of the item, and the value of the item or the amount the item is insured for. The parameters will be received and stored by the service for creating at least one list for each independent courier.

When receiving the parameters associated with each courier job, the service may additionally receive various optional parameters from the courier business listing the courier job which may be used by the service to further determine which independent couriers are qualified or authorized to accept or bid on the courier job. Optional parameters which may be received by the service include a minimum on time percentage for deliveries for an independent courier to be authorized for the courier job, specific independent couriers who are not allowed to accept or bid on a particular courier or shipping job, specific independent couriers who are not allowed to accept or bid on any courier or shipping jobs listed by the courier business, a minimum distance from the pick-up and/or delivery address, an area from which the independent courier must originate, a minimum rating for the independent courier, and the quality for the vehicle being utilized by the independent courier. The courier business may also provide any notes or comments relevant to the courier job which may be needed by the independent courier.

In order to receive the courier job parameters, an interface may be provided by the service which is accessible by courier businesses through any number of available mediums. The interface may provide inputs for any required or optional parameters which the service will use to determine which independent courier(s) is qualified or authorized to accept or bid on the courier job. Any required parameters can be offset from unrequired parameters, or required parameters can be noted with indicia on the interface. The interface may be accessible on a desktop or tablet computer, a laptop, or other Internet read device through the Internet, or through a smart phone app, like for example an Android app. Each registered courier business may be provided with a login and password which will allow the courier business to be linked to the courier job for billing and reporting purposes. One or more forms of interfaces may also be provided which allow courier businesses to register, review and update their account and profile information, and, provide any courier jobs or items for shipment and any required or optional parameters for the same. As will be discussed further herein, an additional interface for each courier business to track independent couriers through the service may also be provided.

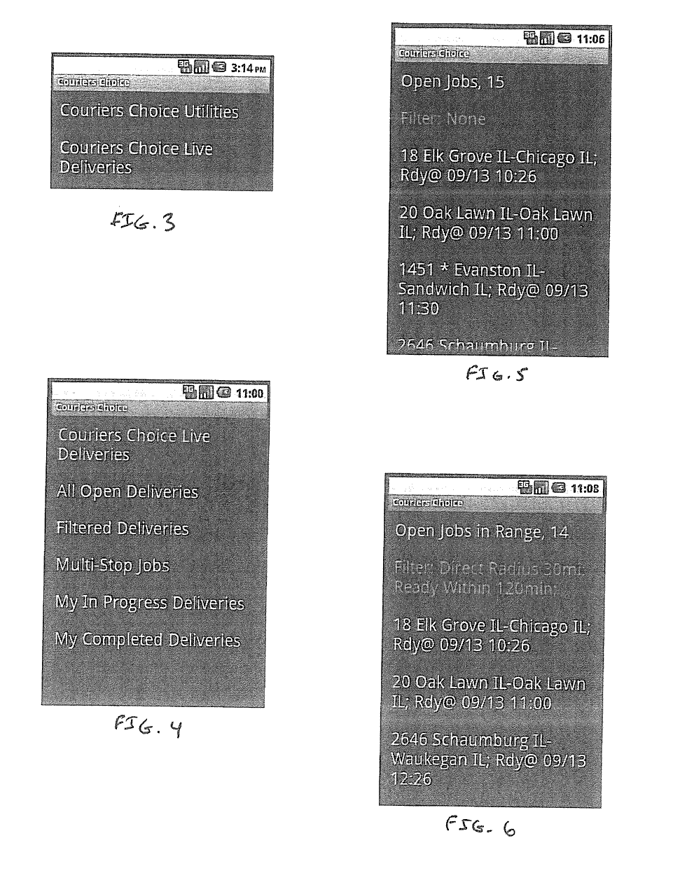

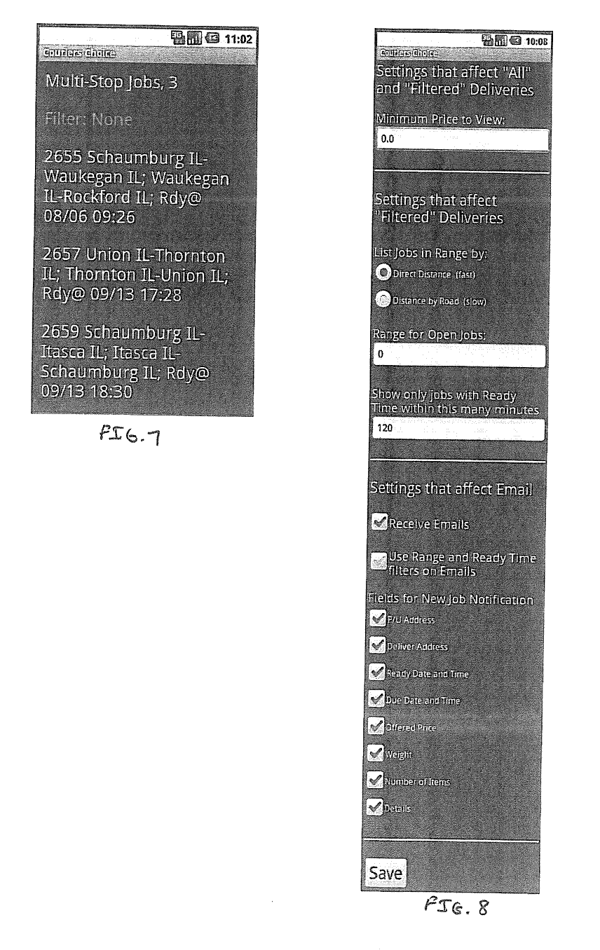

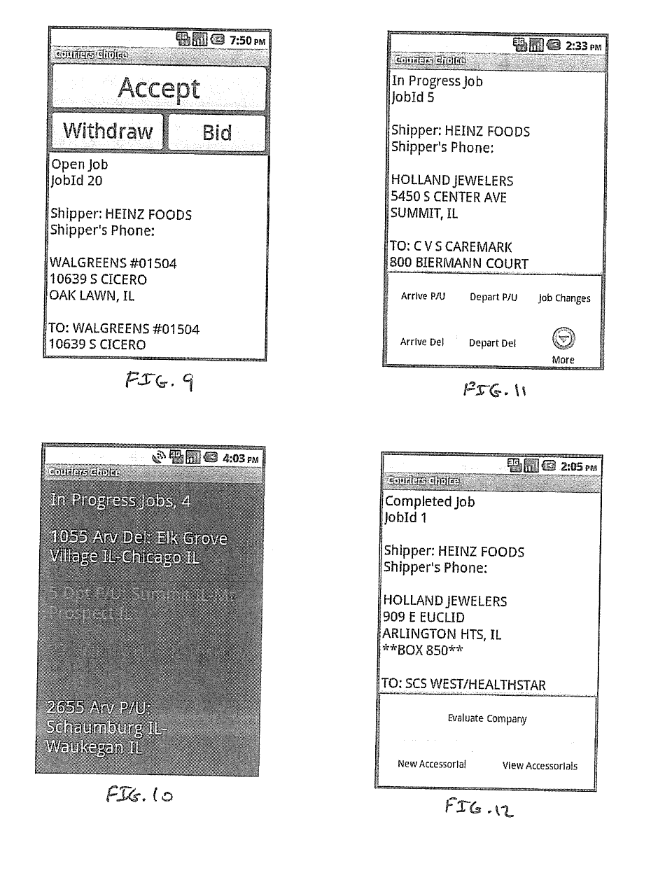

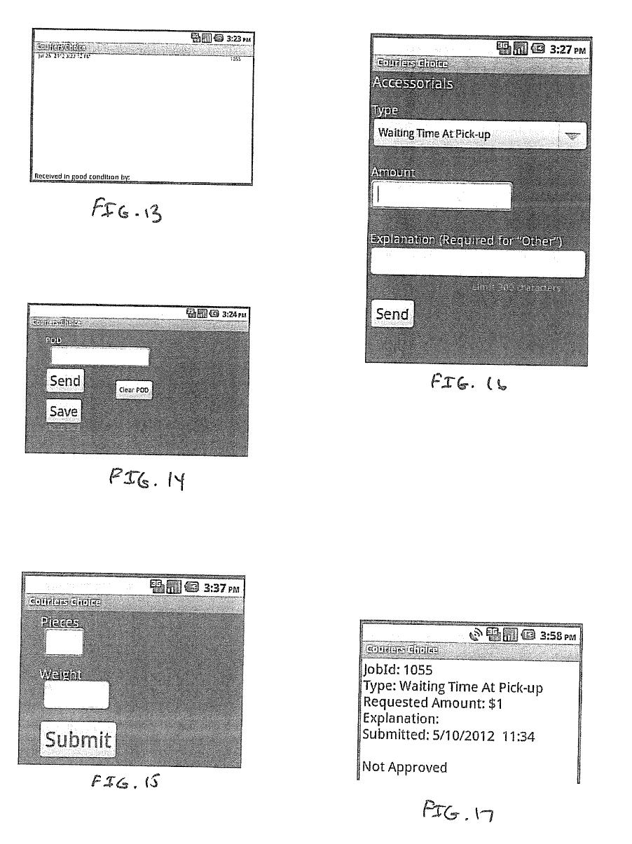

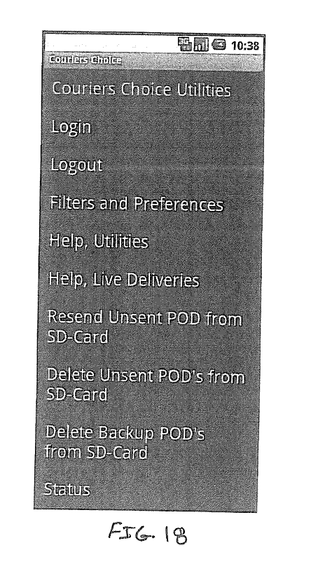

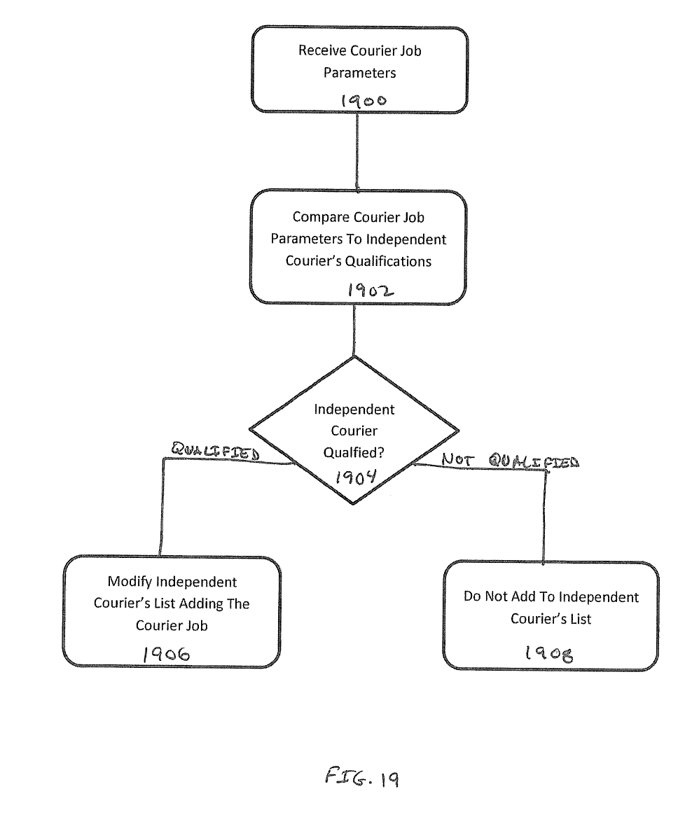

The service may also provide various interfaces usable by each independent courier. For example, one or more interfaces may be provided to each independent courier which will allow each independent courier to register, access their personalized list(s) (shown for example in FIGS. 3-7), update their profile (shown for example in FIG. 8), view details regarding available, pending, or completed courier jobs (shown for example in FIGS. 9-12), obtain proof of delivery (shown for example in FIGS. 13 and 14), request accessorial charges (shown for example in FIGS. 15-17), and view or access other pertinent account information kept by the service (shown for example in FIGS. 3 and 18). These interfaces may be accessible on any type of computer through the Internet. Each independent courier may log into their account through the Internet and view their list and account information and accept or bid on courier jobs. Any required login and passwords may be provided by the service or established by each independent courier after registration is completed. Preferably, though, upon completion of registration, each independent courier will receive an app, like for example an Android app, on their smart phone which will allow them to view each of the various elements shown in FIGS. 3-18 including their list and account information and accept or bid on courier jobs and view the details of any ongoing or completed courier jobs.

As discussed herein, each registered independent courier will have access to at least one personal list created and provided by the service based upon the independent courier's information provided during registration and located in their profile and the parameters received for each courier job by the service. The process for determining which courier jobs may be listed for each independent courier can be seen, for example in FIG. 19. As seen in FIG. 19, the courier jobs received by the service will be reviewed (1900) and compared to each independent courier's profile and qualifications (1902). If the service determines that an independent courier is qualified for the courier job (1904), the independent courier's courier job list will be modified to include the courier job (1906). If the service determines that he independent courier is not qualified (1904), the service will not modify the independent courier's job list (1908). This analysis will be done for each independent courier with respect to each independent courier job. In order for the service to determine that a particular independent courier is qualified or authorized for the courier job, the service may compare the independent courier vehicle to the vehicle required to complete the courier job, the amount of cargo insurance of the independent courier to the required amount of cargo insurance for the courier job, and the licenses that the independent courier has to all required licenses to complete the courier job in a particular location or area. If the service has no record of an independent courier meeting any one of these qualifications, the courier job will not be provided on the independent courier's list, and as a result the independent courier will not be able to accept or bid on the job through the service.

The service will likewise not provide a courier job on any independent courier's list who fails to meet any optional parameters received from the listing courier business. For example, any independent couriers who do not meet a set minimum on time percentage, or are specifically as not being authorized for that particular delivery or any deliveries for the courier business, will likewise not have the courier job provided on their list.

While some independent couriers may have identical lists, each independent courier will be provided with a personalized list which includes all courier jobs or items received by the service that independent courier is qualified or authorized to deliver. If an independent courier accepts a job as offered by a courier company from their provided list, the independent courier will then be responsible for completing the job within the parameters set by the courier business in the listing, and providing any required proof of delivery. The listing for that courier job or item will no longer be able to be accepted by any other independent couriers through the service.

In order to obtain and store all registration and profile information, as well as all listed courier jobs, acceptances, bids, payments, independent and courier business information, and anything else required by the method offered by the service, the service may utilize one or more servers and computer systems which may include one or more databases. The servers, computer systems and databases may categorize, store, review, analyze, and create any information required to provide the method. All software needed to receive the courier jobs, registrations, and create and update any independent courier and courier business profiles, and any personalized lists provided to the independent couriers, will be provided within the server or computer system. The servers or computer systems may also include and provide any necessary interfaces which will allow courier businesses to enter, upload, or list courier jobs thereon, allow independent couriers to access listed courier jobs they are qualified to deliver, and the service to determine any necessary information related to the service and any payments.

The determination of which independent couriers are qualified for each courier job listed with the service may be made by software included on any server, computer systems, and databases automatically each time a new job is listed. For example, the service server and computer systems may keep in a database a single master list or board of all courier jobs listed with the service. The server and computer systems and software may take a courier job each time it is uploaded, and add it to the master list or board. Every courier job on the master list or board may then be compared or reviewed against each independent courier profile stored on the server or in the computer systems. A list provided to each independent courier may then essentially be a modified list which is presented by the service on the Internet or through an associated app via the server and/or computer systems based on the parameters for each courier job on the master list and the independent courier's registration information and profile. The viewable list and courier jobs accessible by each independent courier will be continually updated by the service and the associated server and/or computer system and software each time a new courier job is received and added to the master list or board. Where a master list or board for all courier jobs listed with the service is kept, the server and/or computer system and software may transform the master list into a personalized list for each independent courier registered with the service, or may present a modified version of the master list or board that is viewable by each independent courier when they login into the service.

Alternatively, rather than keep a master list or board, the server and/or computer systems for the service may instead determine which independent couriers are qualified for each courier job that is uploaded to the server and computer systems, and place the job on the personal list of each independent courier. In this sense, the server and/or computer system will modify the list for each independent courier qualified for a courier job every time a courier job is uploaded to the computer system.

When completing courier jobs accepted or bid on through the service, any provided app may remain active, allowing the service to track the independent courier while in transit. As mentioned herein, an interface may be provided by the service to allow courier businesses to track all independent couriers delivering items for them through the service. In order to provide tracking, the app provided by the service may require the use of any location services on the smart phone, and/or may use GPS tracking through the smart phone to provide an approximate location of the independent courier. The app may be designed so that the independent courier does not have the option to turn off location services once the app is turned on and a courier job is in progress.

The app may also be utilized by the service to keep time stamps on action taken by the independent courier. The app may, preferably with input from the independent courier, or on its own based on location information, time stamp the pick-up and delivery for every courier job accepted or won by the independent courier. The time stamp may be received by the service from the app, and used to update the independent courier's on time percentage in the independent courier's profile. The times may also, at the request of the courier business for whom the item is being couriered, be transmitted to the courier business.

During registration or any time thereafter, like for example through a provided app or an interface accessible through Internet on a computer or the like, the service may receive from each independent courier that registers with the service a set of personalized parameters or limitations which may be used by the service to further limit the list of items they may view to accept or bid on for courier or shipment. The service may provide each independent courier with the option to set parameters or limits, for example, on the distance from a registered address or current location the independent courier is willing to pick up or drop off an item, the method in which the distance is reported, the least or most amount of money an independent courier is willing to take a courier job for, and a maximum or minimum ready time for a courier job. The service may additionally provide options for an independent courier to set parameters regarding a minimum or maximum completion time for a courier job, a minimum or maximum distance an independent courier is willing to travel for a courier job, a minimum or maximum courier business rating, specific courier businesses the independent courier prefers or refuses to do deliveries for, minimum or maximum item weights the independent courier is willing to ship or courier, minimum or maximum item value the independent courier is willing to ship or courier, minimum or maximum number of packages in a shipment or courier the independent courier is willing to take, and specific locations or areas the independent courier is unwilling to pick up or deliver an item to. Each independent courier may be provided with an option to select and set any parameters or limits which the service may use to provide a customized list of items available for courier or shipment. It is contemplated by the invention that the settings and parameters selected and set by each independent courier may be changed or altered as desired so that the list may include or exclude additional items. These changes may occur periodically or throughout the day as needed.

The parameters received from each independent courier may be used to create a single list for the independent courier. The single list may include all the jobs which meet the independent courier's parameters that the independent courier has been deemed qualified or authorized for by the service as a result of the independent courier's registration and profile and any parameters set by courier businesses. However, more preferably, the service will provide two lists to each independent courier who sets parameters or limits for courier jobs they are willing to accept.

The first list of the two lists provided by the service to each independent courier will include all courier jobs the service has determined that the independent courier is qualified or authorized to accept or bid on, regardless of the independent courier's set limits or parameters. This list would provide the independent courier with a list of all jobs that they may accept or bid on, allowing the independent courier to bid on or even accept jobs which do not meet their limits or parameters. This list may also help facilitate the completing of some courier jobs listed by courier businesses, and provide independent couriers with an option for selecting courier jobs outside their parameters on any given day.

The second list of the two lists provided by the service to each independent courier will include the jobs from the first list which the service has determined meet the limits or parameters set by the independent courier. The second list will operate in substantially the same manner as the first list, and the acceptance or bidding of jobs will be treated the same way. The second list provided by the service to each independent courier setting parameters will effectively be a modified list from the service, based on the parameters set by both the courier business for each courier job, and each independent courier. The parameters which have been set by the independent courier may be viewable as part of the list so that the independent courier can review and modify the list if necessary.

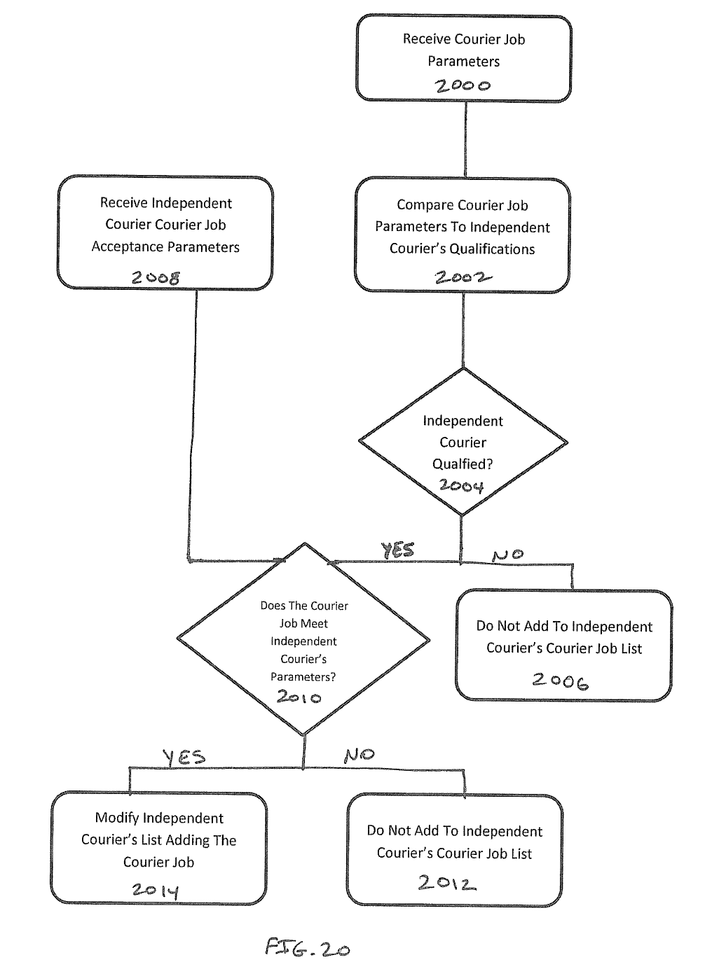

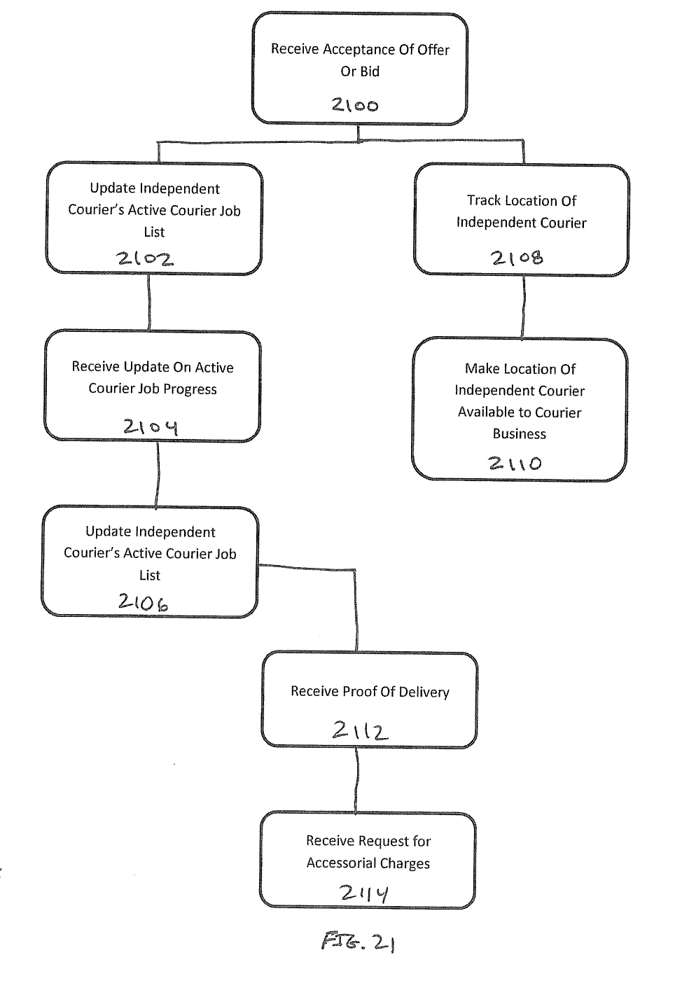

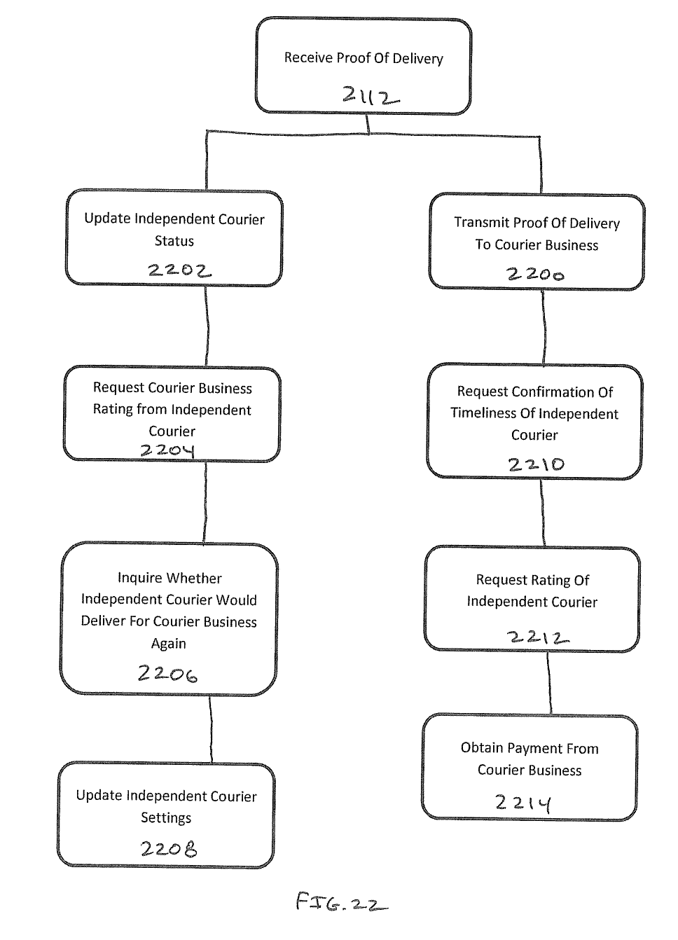

Whether one or two lists are provided to an independent courier, FIG. 20 shows the process through which the service may further limit each independent courier's list based on the independent courier's settings. As shown in FIG. 20, the service may receive courier job parameters (2000) for at least one courier job, compare each of the courier job parameters to the independent courier's qualifications (2002), and determine whether or not the independent courier is qualified to accept or bid on each courier job (2004). If the independent courier is not qualified for a particular courier job, then the courier job will still not be added to their list (2006). Rather than add it to the independent courier's list at this stage if the independent courier is qualified however, the service will receive and review the parameters input or previously provided by the independent courier (2008) and compare the courier job parameters to the independent courier's parameters (2010). If the courier job parameters do not meet the independent courier's parameters, the service will not add the courier job on any list which the independent courier has set to be modified by the parameters (2012). If the parameters of the courier job meets the independent courier's parameters, then the courier job will be added to the limited or filtered list of the independent courier (2014).

The invention further contemplates the service providing a third list to each independent courier whereby courier jobs having more than a pick-up and delivery, i.e. a multi-stop courier job, are listed and detailed. This third list may operate using the parameters from the first list only, or both the first and second list.

Whether the service provides one, two, or three list(s) to each independent courier, each independent courier may also set parameters related to how the lists provided by the service are received and listed. Each independent courier, may, for example, input a setting so that the service will email them the first or second lists above periodically. Each independent courier may also set parameters which set how service orders the list provided to them, for example, by showing closest pick-ups or deliveries or highest payment amounts first. Each independent courier may also indicate or select the fields which are provided either in an email and/or in detailed view of each courier job.

The method for processing accepted courier jobs can be seen in FIG. 21. After the service has received an acceptance for a courier job from an independent courier, or an acceptance of a bid on a courier job from a courier business (2100), the independent courier will be responsible for delivery of the item within the parameters set by the courier business or in the accepted bid. The service will provide or update an open courier job list for the independent courier (2102) which may be viewable through an interface, including the previously discussed app, which provides the parameters and details associated with any open or uncompleted courier jobs that the independent courier has either accepted or won a bid on. An independent courier may provide updates on the status for each open courier job the independent courier has accepted or won a bid for (2104). These statuses may be received by the service and reflected in the independent courier's open courier job list (2106). Status updates may aid in the tracking of any independent couriers, and provide a reminder for independent couriers that a particular courier job needs to be completed. Each independent courier will be tracked (2108) once each independent courier accepts an offer or has a bid accepted by a courier business (2100). As discussed herein, once the tracking begins, the courier business may be provided access to the same (2110) in order to provide estimated arrival times and track the location of items.

Upon delivery, the independent courier may be required to obtain a signed proof of delivery for the item (2112). In a preferred embodiment, the signed proof of delivery will be done through an app provided to the independent courier, like for example as a feature of the app previously discussed herein. When the item is delivered, the independent courier may use the app to access an interface where the recipient sign on the independent courier's smart phone screen. The app may capture the signature, ask for the name of the person signing to be entered, time stamp the signature for time of delivery, and then transmit the proof of delivery including the signature, name, and delivery time to the service. Once the proof of delivery has been transmitted, the independent courier will have an opportunity to request any accessorial charges, which will be received by the service (2114) and further processed as described with respect to FIG. 23 herein.

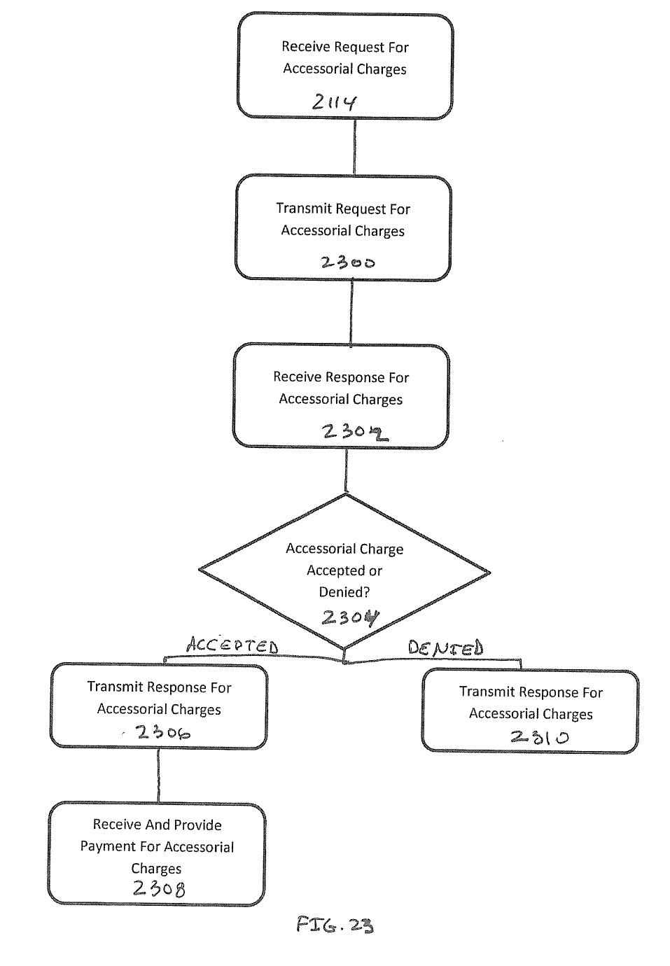

As seen in FIG. 22, the service will receive the proof of delivery from the independent courier (2112), and provide it to the courier business (2200) that listed the courier job and item with the service. Once received, the status for the courier job for the independent courier will be updated to completed (2202). Once the signature is entered, if obtained using the app provided by the service, the app may be configured to automatically transmit all proof of delivery information to the service once it is completed or after a send command is entered by the driver. Alternatively, or if the app is unable to automatically transmit the proof of delivery information due to a lack of signal to the smart phone or damage to the smart phone, the app may store the proof of delivery information on the smart phone or an associated memory card plugged directly into the smart phone for later transmission. Once the independent courier enters an area where the proof of delivery can be transmitted, the app may automatically transmit the signed proof of delivery, or the independent courier may manually transmit the proof of delivery to the service through the app. The service will again receive the proof of delivery and transmit the same to the courier business that listed the courier job and item with the service.

As a further alternative, or if no app is provided or the independent courier does not have a compatible or any smart phone, or in case the app fails or the independent courier's smart phone fails, it is contemplated by the invention that the independent courier may instead be required to obtain a hand written proof of delivery. Such proofs of delivery may be received by the service, like for example through email or fax, and be entered by the service into the record for the listing of the courier job and item. Once the proof of delivery is entered, the service will then automatically forward the proof of delivery to the courier business.

After any requested or required proof of delivery has been received by the service, the service, through any app or a later survey accessible via the Internet, may ask the independent courier to rate the courier business for whom they just completed the courier job (2204). As part of this survey, the service may ask the independent courier to answer whether or not the independent courier would be willing to take future courier jobs from that courier business (2206). If the independent courier answers yes, the courier business's courier jobs and items will remain listed on one or both of the independent courier's list(s). If the independent courier answers no, the courier business's listed courier jobs and items will be removed from one or more of the independent courier's lists and the independent courier will no longer be able to view the courier jobs listed by that courier business (2208).

Any rating received by the service from the independent courier will be used by the service to update the courier business's rating and profile. The service may receive a simple overall rating for the experience dealing with the courier business. The service may additionally or alternatively request and receive a categorical rating which includes such items rating the courier business for the availability of the item at the set time for pick-up, the accuracy of the description of the item, the ease of access to the courier business, acceptance or denial of any accessorial charges, and the friendliness of the staff. The service may also receive comments or the like to include in the courier business's registration and profile and to provide with each listing the courier business enters with the service.

After receiving proof of delivery for a courier job and providing it to the courier business who listed the courier job, the service will ask the courier business to confirm any on time or late settings automatically set in the individual courier's profile related to the courier job (2210), and request that the courier business rate the individual courier (2212). For individual courier ratings, the service may once again receive a basic overall rating, plus any additional sub-ratings or categorical ratings related to the independent courier who just completed the courier job through the service. Categories which the service may ask a courier business to rate an independent courier on include but are not limited to on time pick-up, on time delivery, condition of the item upon arrival, correct delivery location, all items delivered complete, correct vehicle size, vehicle condition, how well the independent courier followed any special instructions, the independent courier's communication skills, and the independent courier's hygiene and appearance. The service may also ask for and receive any additional comments that the courier business wants to provide relative to the independent courier.

Payment for each courier job listed with the service will be received by the service from the courier business and provided to each independent courier (2214). Once payment is received, the service will note which courier job the payment is for and credit the proper independent courier's account. The service may pay each independent courier upon receipt or periodically. Periodic payments may be set by the service, or alternatively, each independent courier may be provided with options to set the periods for payment for that independent courier. As the payments are received and made, the service will update each independent courier's profile and/or an account. At the end of the year, the service will provide each independent courier with a 1099 form for operating as independent contractors. Since the courier jobs are listed with the service and paid by the service, the service will be responsible for such forms, not each individual courier business. If payments are not received from a courier business, the service may disallow the courier business from listing courier jobs or items with the service.

The service may receive requests for accessorial or additional charges from any independent couriers if any parameters provided by a courier business are incorrect, or if the courier business fails to meet any of its parameters or causes the independent courier to be delayed, as detailed in FIG. 23. Accessorial or additional charges received by the service (2114) from an independent courier may result from the courier business indicating the wrong weight or number of packages in a listing, indicating the wrong pick-up place or delivery address, any unexpected tolls incurred, and the item not being available for pick-up at the given time or delivery not being completable by the given time. The independent courier may provide an indication or report to the service at the time of pick-up to indicate that the number of items or the total weight of the item(s) is different than the parameters provided on the independent courier's list.

Upon receipt of any accessorial charges for any given courier job or item, the service will transmit the request to the courier business (2300). The service will receive a response from the courier business (2302) either, that no, it will not accept the accessorial charge, or yes, it will. The service will then act accordingly based upon the response received from the courier business (2306). If the service receives a response that yes, the courier business will accept the accessorial charge(s) or provide some other amount, the service will provide the received response to the independent courier requesting the accessorial charge (2306) and receive payment from the courier business (2308). The service will then pay the independent courier the collected fee for the accessorial charge. Payment may be made immediately, or alternatively, may be made along with any periodic payments from the service to the independent courier. In response to any accessorial charges, a courier business may also be provided with the option to decline the amount requested by the independent courier and provide a different amount. If the service receives a response that no, the courier business will not accept the accessorial charges, the response will be transmitted to the independent courier requesting the accessorial charge (2310) and no receipt or payment of additional funds will be undertaken by the service.

The above-described embodiments of the present invention are intended to be examples only. Alterations, modifications and variations may be effected to the particular embodiments by those of ordinary skill in the art without departing from the scope of the invention, which is defined by the claims appended hereto.

What is claimed is:

1. A method of facilitating the shipment of items, the method comprising the steps of:
registering at least one independent courier and creating an independent courier profile;
registering at least one courier business and creating a courier business profile;
receiving parameters associated with couriering of at least one item from the at least one courier business;
determining whether the at least one independent courier is qualified to courier the at least one item based on the parameters and the independent courier profile;
providing the parameters for couriering the at least one item to the at least one independent courier on a list if the at least one independent courier is qualified to courier the at least one item; and,
modifying the list provided to the at least one independent courier every time parameters for an item for courier that the independent courier is qualified to courier is received.

2. The method of facilitating shipment of claim 1 further comprising the steps of:
receiving proof of delivery from the at least one independent courier each time the at least one independent courier delivers an item for courier selected off the list; and
providing the proof of delivery to the at least one courier business.

3. The method of facilitating shipment of claim 2 further comprising the steps of:
requesting a rating from the at least one courier business for the at least one courier each time an item for which parameters are received for courier after proof of delivery is provided for the item from the at least one independent courier; and
receiving the rating from the at least one courier business and updating an independent courier rating for the at least one independent courier.

4. The method of facilitating shipment of claim 1 further comprising the steps of:
receiving payment from the at least one courier business from which parameters for at least one items for courier are received; and
paying the at least one independent courier for couriering the item.

5. The method of facilitating shipment of claim 4 further comprising the step of paying the at least independent courier periodically for all couriered items.

6. The method of facilitating shipment of claim 1 further comprising the step of receiving information from the at least one independent courier related to the at least one independent courier vehicles used for couriering, courier insurance protection, and courier licenses when registering the at least one independent courier.

7. The method of facilitating shipment of claim 6 further comprising the step of receiving at least one parameter from the at least one independent courier, the at least one parameter providing limitations on item couriering the at least one independent courier is willing to accept.

8. The method of facilitating shipment of claim 7 further comprising the step of providing a second list to the at least one independent courier, the second list having only parameters for items for couriering for which the at least one independent courier is qualified to courier, and which fit in the limitations on item couriering set by the at least one independent courier.

9. The method of facilitating shipment of claim 1 further comprising the step of providing an app to the at least one independent courier after registration, the app being used by the at least one independent courier to access the list.

10. The method of facilitating shipment of claim 1 further comprising the step of requesting a rating for the at least one courier business from the at least one independent courier each time the at least one independent courier couriers an item for the at least one courier businesses.

11. The method of facilitating shipment of claim 10 further comprising the step of receiving the rating from the at least one independent courier and inquiring as to whether the at least one independent courier wants to deliver another item for the at least one courier business having listed parameters that the at least one independent courier is qualified to courier.

12. The method of facilitating shipment of claim 1 further comprising the steps of
receiving a request for an accessorial charge from the at least one independent courier related to an item being couriered by the at least one independent courier;
requesting acceptance of the accessorial charge from the at least one courier business the items is being couriered for;
receiving a response from the at least one courier business whether or not the accessorial charge will be paid; and
providing the at least one courier business response to the at least one independent courier requesting the accessorial charge.

13. The method of facilitating shipment of claim 12 further comprising the steps of:
receiving an acceptance from the at least one courier business to pay for accessorial charge;
receiving payment from the at least one courier business; and
paying the at least one independent courier who requested the accessorial charge.

14. The method of facilitating shipment of claim 1 further comprising the step of notifying the at least one independent courier whether or not the bid entered for a list item has been accepted.

15. The method of facilitating shipment of claim 1 further comprising the steps of:
receiving instructions to withdraw a bid received from the at least one independent courier to courier one of the at least one items on the list; and
notifying the at least one courier business listing the item for courier that the bid has been withdrawn.

16. A method of facilitating the shipment of items, the method comprising the steps of:
registering independent couriers;
storing an independent courier profile for each registered independent courier on a server, each independent courier profile including the information provided during registration;
registering courier businesses;
storing a courier business profile for each registered courier business on the server, each courier business profile including the information provided during registration;
receiving parameters for courier jobs from the courier businesses;
storing the parameters for the courier jobs on the server;
determining which independent couriers are qualified to accept or bid on each courier job based on the independent courier profile;
providing a list to each independent courier detailing the parameters for each courier job the server has determined each independent courier is qualified to accept or bid on; and
modifying each independent courier list every time parameters are received for a new courier job each independent courier is qualified to accept or bid on.

17. The method of facilitating shipment of claim 16 further comprising the steps of:
receiving proof of delivery from each independent courier every time each independent courier completes a courier job; and
providing the proof of delivery to a courier business that provided the parameters for the courier job.

18. The method of facilitating shipment of claim 17 further comprising the steps of:
requesting a rating from the courier business for an independent courier after the proof of delivery is provided to the courier business; and
receiving the rating from the courier business and updating an independent courier rating for the independent courier.

19. The method of facilitating shipment of claim 16 further comprising the steps of:
receiving payment from each courier business every time a courier job listed by a courier business is completed; and
paying an independent courier for completing the courier job.

20. The method of facilitating shipment of claim 19 further comprising the step of paying each independent courier periodically for courier jobs completed by each independent courier.

21. The method of facilitating shipment of claim 16 further comprising the step of receiving information from each independent courier related to the vehicles used for couriering, courier insurance protection, and courier licenses for each independent courier during registration.

22. The method of facilitating shipment of claim 21 further comprising the step of receiving at least one parameter from at least one independent courier, the at least one parameter providing limitations on courier jobs the at least one independent courier is willing to accept.

23. The method of facilitating shipment of claim 22 further comprising the step of providing a second list to the at least one independent courier, the second list having only parameters for courier jobs for which the at least one independent courier is qualified to courier, and which fit in the limitations on courier jobs set by the at least one independent courier.

24. The method of facilitating shipment of claim 16 further comprising the step of providing an app to each independent courier after registration, the app being used by each independent courier to access the list.

25. The method of facilitating shipment of claim 16 further comprising the step of requesting a rating for each courier business from each independent courier each time each independent courier completes a courier job for each courier businesses.

26. The method of facilitating shipment of claim 25 further comprising the step of receiving the ratings from each one independent courier and inquiring as to whether each independent courier wants to deliver another item for a courier business each independent courier just completed a courier job for.

27. The method of facilitating shipment of claim 16 further comprising the steps of
receiving a request for an accessorial charge from at least one independent courier related to courier job being completed by the at least one independent courier;
requesting acceptance of the accessorial charge from a courier business that provided the parameters for the courier job;
receiving a response from the courier business whether or not the accessorial charge will be paid; and
providing the courier business response to the at least one independent courier requesting the accessorial charge.

28. The method of facilitating shipment of claim 27 further comprising the steps of:
receiving an acceptance from the courier business to pay for accessorial charge;
receiving payment from the courier business; and
paying the at least one independent courier who requested the accessorial charge.
